(19) United States
(12) Patent Application Publication
(10) Pub. No.: US 2010/0027293 A1
(43) Pub. Date: Feb. 4, 2010

(54) Light Emitting Panel

(75) Inventor: Yi-Qun Li, Danville, CA (US)

Correspondence Address: FLIESLER MEYER LLP, 650 CALIFORNIA STREET, 14TH FLOOR, SAN FRANCISCO, CA, 94108, US

(73) Assignee: INTEMATIX CORPORATION, Fremont, CA (US)

(21) Appl. No.: 12/182,835

(22) Filed: Jul. 30, 2008

(51) Int. Cl. F21V 8/00

(52) U.S. Cl. 362/619

(57) ABSTRACT

A light emitting panel comprises a light guiding medium having at least one light emitting face and a plurality of light sources (LEDs) configured to couple light into an edge of the light guiding medium at four or fewer locations around the edge. A pattern of optical features (discontinuities) is provided on at least one face of the light guiding medium for promoting emission of light from the light emitting face. The pattern of features is configured such as to reduce a variation in emitted light intensity over substantially the entire surface of the light emitting face such that the variation is less than or equal to about 25%. The pattern of features is configured in part in dependence on a light intensity distribution within the light guiding medium and the spacing, size, shape and/or number of features per unit area can depend on distance from each light source.

### BACKGROUND OF THE INVENTION

1. Field of the invention

This invention relates to a light emitting panel comprising a light guiding medium having at least one light emitting face. More specifically, although not exclusively, embodiments of the invention are directed to a light emitting panel that is substantially planar in form in which light from a light source, typically a light emitting diode (LED), is coupled into one or more edges of the light guiding medium and then emitted from the light emitting face.

2. Description of the Related Art

A lighting fixture commonly found in offices and commercial premises is a fluorescent lighting panel. Generally, such lighting panels comprise a light box comprising an enclosure housing one or more fluorescent tubes and a front diffusing panel. Typically, the diffusing panel is a translucent plastics material or a transparent plastics material with a regular surface patterning to promote a uniform light emission. Alternatively, a louvered front cover can be used to diffuse the emitted light. Such lighting panels are often intended for use in a suspended (drop) ceiling in which a grid of support members (T bars) are suspended from the ceiling by cables and ceiling tiles supported by the grid of support members. The ceiling tiles can be square or rectangular in shape and the lighting panel module is configured to fit within such openings with the diffusing panel replacing the ceiling tile.

White light generating LEDs, “white LEDs”, are a relatively recent innovation and offer the potential for a whole new generation of energy efficient lighting systems to come into existence. It is predicted that white LEDs could replace incandescent, fluorescent and compact fluorescent light sources due to their long operating lifetimes, potentially many 100,000 of hours, and their high efficiency in terms of low power consumption. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more phosphor materials, that is photo-luminescent materials, which absorb a portion of the radiation emitted by the LED and re-emit light of a different color (wavelength). Typically, the LED chip or die generates blue light and the phosphor(s) absorbs a percentage of the blue light and re-emits yellow light or a combination of green and red light, green and yellow light or yellow and red light. The portion of the blue light generated by the LED that is not absorbed by the phosphor is combined with the light emitted by the phosphor to provide light which appears to the human eye as being nearly white in color.

To date high brightness white LEDs are increasingly being been used to replace conventional fluorescent and incandescent bulbs. Today, most lighting fixture designs utilizing white LEDs comprise systems in which a white LED (more often an array of white LEDs) replaces the conventional light source component. Due to their compact size, compared with conventional light sources, white LEDs make it practical to construct compact lighting panels that are edge-lit as opposed to the traditional back-lit lighting panels. One such white LED edge-lit lighting fixture is Neo-Neon International Ltd's “I Panel” that is shown as a perspective partial cut-away schematic in FIG. 1. The lighting panel 1 comprises a layered construction comprising a light reflecting rear layer 2, a light guiding panel 3, a light diffusing layer 4 and a protective transparent front layer 5. The light guiding panel 3 and protective front layer 5 each comprise sheets of a clear plastics material such as a polycarbonate whilst the reflecting rear layer 2 comprises a sheet of opaque white plastics material and the diffusing layer 4 comprises a sheet of translucent plastics material. A series of curved indents 6 that run through the thickness of the light guiding panel are provided along each of its edges to assist in coupling light 7 into the light guiding panel 3 from an associated white LED 8. The white LEDs 8 are mounted on a circuit board 9 which is in thermal communication with a surrounding metal frame (not shown). To promote a more uniform emission of light 11 from a light emitting front face 12 of the lighting panel (in FIG. 1 the light emitting front face 12 is the lower face) a number of relatively low power (e.g. 1 watt) white LEDs 8 are provided along each of the edges of the lighting panel. For example a 600 mm square panel has fifty six 1 watt LEDs mounted at a spacing of 40 mm around the periphery of the light guiding panel. To reduce the emission of light from the edges of the light guiding panel a reflective material 13, such as an opaque white plastics material, is provided on the edges of the panel 3 between the indents 6.

To further encourage a uniform emission of light from the light emitting front face 12, the opposite rear face 14 of the light guiding panel 3 has a hexagonal array of circular areas 15 over its entire surface. Each circular area 15 comprises a circular surface roughening of the light guiding panel and is typically 1 mm in diameter with a spacing of 2 mm between centers of neighboring areas. The circular areas cause a disruption to the light guiding properties of the light guiding panel 3 resulting in a preferential emission of light at the site of each circular area 15 towards the reflecting rear layer 2. Light that is emitted by the circular areas is reflected by the reflecting rear layer 2 back through the light guiding panel and is emitted through the front light emitting face 12. In operation white light 7 emitted by the white LEDs 8 is coupled into the light guiding panel 3 via the indents 6 and is guided throughout the bulk of the light guiding panel 3 by total internal reflection. Light 11 is emitted substantially uniformly from the light emitting face 12 due to the presence of the regular pattern of circular areas 15.

An advantage of an edge-lit lighting panel compared to a back-lit panel is its compact nature, especially overall thickness of the fixture which can be substantially the same as the thickness of the light guiding panel. Whilst such lighting systems work well, their light emission is not truly uniform over the entire light emitting face. For example there can be “hot spots” along the edges that correspond to the position of the LEDs and a dark region at the centre of the panel. Typically, the emitted light intensity at the edges and center of such a panel can be in a range 13 to 18 Lux, that is as much as a 30% variation from the edges to the center. As described, to alleviate the problem of emission intensity uniformity a large number of closely spaced lower power LEDs can be used though this significantly increases the cost of the lighting panel.

In addition to lighting applications light emitting panels, especially edge-lit panels, are used as backlights in liquid crystal displays (LCD) such as televisions and monitors. In such applications the uniformity of emission is especially important for accurate color rendering of the display. US 2008/0049445 teaches a corner coupled backlight in which light from one or more LEDs is coupled to a truncated corner of a solid rectangular light guide. In one embodiment, a high-power, white LED is mounted in a small reflective cavity, which is then coupled to a truncated corner of the light guide. The reflective cavity provides a more uniform light distribution at a wide variety of angles to the face of the truncated corner to better distribute light throughout the entire volume of the light guide.

Co-pending U.S. patent application Ser. No. 11/827,890 (filed Jul. 13, 2006) describes an edge-lit lighting panel which utilizes blue LEDs instead of white LEDs. A layer of one or more blue light excitable phosphor materials is provided on the light emitting face of the panel. A proportion of the blue light emitted from the light emitting face of the panel is absorbed by the phosphor material(s) and other color(s) light emitted by the phosphor. The blue light from the LEDs combined with the phosphor generated light produces an illumination product that appears white in color. An advantage of providing the phosphor remote to the LED is that light generation, photo-luminescence, occurs over the entire light emitting surface area of the panel. This can lead to a more uniform color and/or correlated color temperature (CCT) though “hot spots” can still occur in the vicinity of the LEDs. A further advantage of locating the phosphor remote to the LED is that less heat is transferred to the phosphor, reducing thermal degradation of the phosphor.

US 2008/0112183 discloses a lighting device comprising a disc-shaped light guide with a series of LEDs located around the edge of the light guide. The light guide can be circular or square and has LEDs equally spaced respectively around the circumferential edge/sides of the light guide. Optical layers with a lower refractive index than that of the light guide are provided on the front light emitting and rear faces of the light guide. A reflector is provided on the optical layer on the rear face of the light guide to reduce light emission from the rear of the device. The optical layer in contact with the light emitting face of the light guide has a regular grid of lines to encourage the emission of light from the light emitting face.

It is an object of the present invention is to improve the uniformity of light emission from a light emitting panel and to reduce the cost of manufacture.

### SUMMARY OF THE INVENTION

Embodiments of the invention are directed to a light emitting panel comprising a light guiding medium in which light is coupled into one or edges of the medium such that it is waveguided, by total internal reflection, throughout the volume of the medium. The light guiding medium has at least one light emitting face and a pattern of optical features or discontinuities provided on the light emitting face and/or opposite face of the medium for promoting emission of light from the light emitting face. The pattern of features is configured to reduce a variation in emitted light intensity over substantially the entire surface of the light emitting face. Typically, the variation in intensity will be less than or equal to about 25% though in some embodiments the variation can be about 10% or less.

According to the invention a light emitting panel comprises: a polygonal-shaped light guiding medium having a light emitting face, an opposite face and truncated corners, at least one light source associated with each truncated corner of the light guiding medium and configured to couple light into the associated truncated corner and a pattern of features on at least one face of the light guiding medium for promoting emission of light from the light emitting face, said pattern of features being configured such that a variation in emitted light intensity over substantially the entire surface of the light emitting face is less than or equal to about 25%. A particular advantage of the invention is that fewer relatively higher power light sources, typically LEDs or LED arrays, can be utilized thereby reducing cost and at the same time a substantially uniform emission intensity achieved using an appropriate surface patterning of the light guiding medium. By careful configuration of the pattern of features the intensity of hot spots can be reduced and the dark region in the center of the panel reduced.

In typical applications of the invention such as general lighting or back-lighting of liquid crystal displays, the light guiding medium will be square or rectangular in shape and for such applications only four LEDs/LED arrays will be required in which one is associated with a respective corner of the light guiding medium.

The pattern of features can be configured, at least in part, in dependence on a light intensity distribution within the light guiding medium which can be calculated or derived empirically. Since the light distribution is non-uniform and will vary with distance from each light source, the spacing of features can depend on the distance from each light source. Typically, the spacing will reduce as the intensity falls with increasing distance from each light source. Alternatively and/or in addition the size and/or shape of the features can depend upon the distance from each light source. Moreover, the pattern can also be configured such that the number of features per unit area increases in dependence on distance from each light source.

To maximize coupling of light into the light guiding medium at least one substantially hemispherical (dish-shaped) indentation in an edge of the light guiding medium is associated with each light source in which the indentations are provided in the truncated corners of the light guiding medium and wherein the associated light source is positioned at substantially the center of the indentation. The indentations are configured, that is their curvature and/or diameter, such as to maximize the proportion of light from the associated light source that strikes the surface of the indentation at substantially normal incidence and thereby maximizes coupling of light into the light guiding medium.

In one arrangement the features are formed as an integral part of the light guiding medium, by for example precision molding the light guiding medium. Alternatively, and/or in addition the face of the light guiding medium can be processed to define the features by for example selectively mechanically abrading, grinding, milling, scribing, etching, blasting with abrasive particles or laser ablating the face of the light guiding medium. In a further arrangement the features can be applied to the face of the light guiding medium by for example screen printing features that comprise a material with a different index of refraction to that of the light guiding medium. Preferably such features have a refractive index that is similar to or lower than the light guiding medium to provide a degree of index matching.

Typically, when the features are applied to the face of the light guide they will be essentially 2-dimensional in form and can comprise for example lines (straight or curved), substantially circular; substantially elliptical, substantially polygonal, substantially triangular, substantially square, substantially rectangular or substantially hexagonal shaped features. Alternatively, the features can be 3-dimensional in form and project into, or extend out of, the face of the light guiding medium. Such features can comprise many forms including, for example, features that are ridges (e.g. u- or v-shaped), grooves (e.g. u- or v-shaped), substantially hemispherical features, substantially pyramidal features, substantially tetrahedral features or substantially trapezohedral features.

The light emitting panel of the invention is particularly suited to general lighting or as a back-light for a liquid crystal display and in such applications the light emitting face will be substantially planar in form. Moreover, the light guiding medium will typically be substantially rectangular or substantially square in shape and will depend upon a given application. In other applications the light guiding medium can be substantially triangular or substantially hexagonal in shape. Moreover, it is contemplated in other implementations that the light emitting face of the light guiding medium can comprise a curved surface.

Advantageously the light guiding medium can comprise a transparent material such as a polymer, a polycarbonate, an acrylic or a glass. Preferably, the at least one light source comprises an LED or an array of LEDs.

To maximize light emission from the light emitting face the light source further comprises a reflective surface over substantially the entire opposite face of the light guiding medium.

In a preferred implementation the light emitting panel further comprises a phosphor material positioned over substantially the entire light emitting face of the light guiding medium, wherein the phosphor material is operable to absorb at least a part of the light emitted from the light emitting face and in response emits light of a different wavelength and wherein the light emission product of the panel comprises light generated by the at least one source and the phosphor generated light. Providing a phosphor material over substantially the entire light emitting face of the light guiding medium ensures a uniform color and/or correlated color temperature of generated light compared with arrangements in which the phosphor is incorporated as a part of the LED. In one arrangement the phosphor material can be provided as at least one layer on the light emitting face of the light guiding medium. Alternatively, the phosphor can be provided as a layer on a face of a transparent substrate, such as for example a sheet of polymer material, and the transparent substrate then positioned with the phosphor layer facing the light emitting face of the light guiding medium. An advantage of providing the phosphor on a transparent substrate rather than directly on the light guiding medium is that it easier to deposit a uniform thickness and homogeneous layer of phosphor on a planar surface (that is a surface without a pattern of surface features as can be present on the light emitting face of the light guiding medium). A further advantage of using a transparent substrate is that it provides environmental protection of the phosphor material. In yet a further arrangement the phosphor material can be mixed with a transparent material, typically a polymer material and the phosphor/polymer mixture then extruded to form a homogeneous phosphor/polymer sheet with a uniform distribution of phosphor throughout its volume. The phosphor sheet can then be positioned over the light emitting face of the light guiding medium and such an arrangement eliminates the need for an additional protection layer.

To ensure a uniform emission of light, the light source can further comprise a light diffusing material provided over substantially the entire light emitting face of the light guiding medium. Preferably, the diffusing material is incorporated within or provided on the transparent substrate.

To further increase the intensity of light emission, the panel can further comprise one or more light sources that is/are configured to couple light into an edge of the light guiding medium between the truncated corners of the light guiding medium.

As well as a light emitting panel having a single light emitting face it is also contemplated to provide a light emitting panel in which light is emitted from both faces of the light guiding medium. Such a lighting panel can, for example, be used a dividing partition between cubicles in an office. In such a panel a respective pattern of features is provided on each face of the light guiding medium. In applications where it is required that the light emission intensity from each face is substantially identical the pattern of features will be substantially identical. Conversely, in applications where it is required to have different light emission intensities from each face differing patterns of features can be used on each face.

According to a further aspect of the invention in which the light guiding medium is not necessarily polygonal in shape, a light emitting panel comprises: a light guiding medium having a light emitting face and an opposite face, a plurality of light sources configured to couple light into an edge of the light guiding medium at four or fewer locations around the edge and a pattern of features on at least one face of the light guiding medium for promoting emission of light from the light emitting face, said pattern of features being configured such that a variation in emitted light intensity over substantially the entire surface of the light emitting face is less than or equal to about 25%. By limiting the number of locations at which light sources (LEDs) are provided can reduce cost. In one arrangement the light guiding medium is substantially circular in shape and the light sources are preferably positioned at orthogonal positions around the circumferential edge.

As with the light emitting panel according to the first aspect of the invention the pattern of features can be configured at least in part in dependence on a light intensity distribution within the light guiding medium and typically the spacing, shape and/or number of features per unit of features will depend on the distance from each light source. The features can project into, or extend out of, the face of the light guiding medium and comprise: ridges; u-shaped ridges; v-shaped ridges; grooves; u-shaped grooves; v-shaped grooves; substantially hemispherical features; substantially pyramidal features; substantially tetrahedral features; substantially trapezohedral features; lines; substantially circular features; substantially elliptical features; substantially square features; substantially rectangular features; substantially triangular features; substantially hexagonal features and substantially polygonal shaped features.

To maximize coupling of light from the light sources into the light guiding medium the panel can further comprise at least one substantially hemispherical indentation associated with each light source, said indentations being provided in the edge of the light guiding medium and wherein the associated light source positioned at substantially the center of the indentation.

The features can be formed as an integral part of the light guiding medium by for example precision molding of the light guiding medium. Alternatively and/or in addition the pattern of features can be defined by processing a face of the light guiding medium including for example selectively mechanically abrading the face, selectively grinding the face, selectively scribing the face, selectively etching the face, selectively blasting the face with abrasive particles or selectively laser ablating the face to define the features. In yet a further implementation the features can be applied to the face of the light guiding medium.

In order to generate a required color and/or color temperature of emitted light the panel preferably further comprises a phosphor material over substantially the entire light emitting face of the light guiding medium, wherein the phosphor material is operable to absorb at least a part of the light emitted from the light emitting face and in response emit light of a different wavelength and wherein the light emission product of the panel comprises light generated by the at least one source and the phosphor generated light. The phosphor material can be provided as at least one layer on the light emitting face of the light guiding medium. Alternatively, the phosphor material can be provided as a part of a transparent substrate that is then positioned overlying the light emitting face of the light guiding medium. In one implementation the phosphor material is provided as at least one layer on a face of the transparent substrate and the substrate positioned over the light guiding medium with the layer of phosphor facing the light emitting face of the light guiding medium. Alternatively, the phosphor material is incorporated in the transparent substrate material, typically a polymer material, such that there is a substantially uniform distribution of phosphor throughout its volume.

The light guiding medium is preferably substantially circular, substantially rectangular, substantially triangular or substantially square in shape. When the light guiding medium is polygonal in shape the light sources are preferably positioned at the corners and the corners preferably truncated to assist in coupling light into the medium.

The light guiding medium can comprise any material that is substantially transparent to light emitted by the light sources and phosphor generated light and preferably comprises a polycarbonate, an acrylic or a glass.

To maximize the emission of light from the light emitting face the panel can further comprise a reflective surface over substantially the entire opposite face of the light guiding medium.

### BRIEF DESCRIPTION OF THE DRAWINGS

In order that the present invention is better understood embodiments of the invention will now be described, by way of example only, with reference to the accompanying drawings in which:

FIG. 1 is a perspective partial cut-away schematic of a known light emitting panel as previously described;

FIGS. 2(a), 2(b) and 2(c) are schematic cross-sectional representations of light emitting panels according to the invention;

FIG. 3(a) is a schematic cross-sectional representation of a light guide showing coupling of light into a planar edge of the light guide;

FIG. 3(b) is a schematic cross-sectional representation of a light guide showing coupling of light into the light guide using a hemispherical indentation in the edge of the light guide;

FIG. 3(c) is a schematic perspective representation illustrating a truncated corner of the light guide and a hemispherical indentation for coupling light into the light guide;

FIG. 4 shows examples of features used in light emitting panels in accordance with the invention;

FIG. 5 is a schematic representation in plan view of a light emitting panel in accordance with the invention;

FIG. 6 is a schematic representation in plan view of a light emitting panel according to a further of the embodiment of the invention;

FIG. 7 is a schematic representation in plan view of a light emitting panel according to a further of the embodiment of the invention;

FIG. 8 is a schematic representation in plan view of a light emitting panel according to a yet further of the embodiment of the invention;

FIG. 9 is a schematic representation in plan view of a light emitting panel according to a yet further of the embodiment of the invention;

FIG. 10 is a schematic representation in plan view of a light emitting panel according to a yet further of the embodiment of the invention; and

FIG. 11 is a schematic representation in plan view of a light emitting panel according to a yet further of the embodiment of the invention.

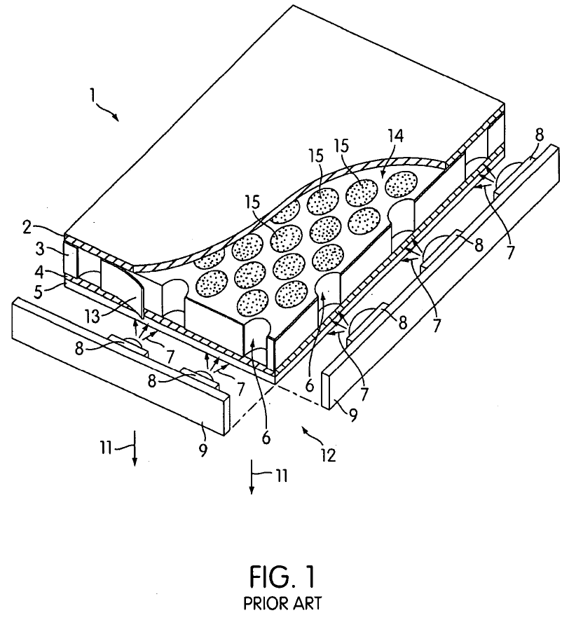

### DETAILED DESCRIPTION OF THE INVENTION

Embodiments of the invention are directed to a light emitting panel comprising a light guiding medium in which light is coupled into one or more edges of the medium such that it is waveguided, by total internal reflection, throughout the volume of the medium. The light guiding medium has at least one light emitting face and a pattern of optical features or optical discontinuities on the light emitting face and/or opposite face of the medium for promoting emission of light from the light emitting face. The pattern of features is configured such as to reduce, preferably minimize, a variation in emitted light intensity over substantially the entire surface of the light emitting face, that is the pattern of features promotes a substantially uniform light emission intensity from the light emitting face. In embodiments of the invention the variation in intensity is typically less than or equal to about 25% and is preferably less than or equal to 10%.

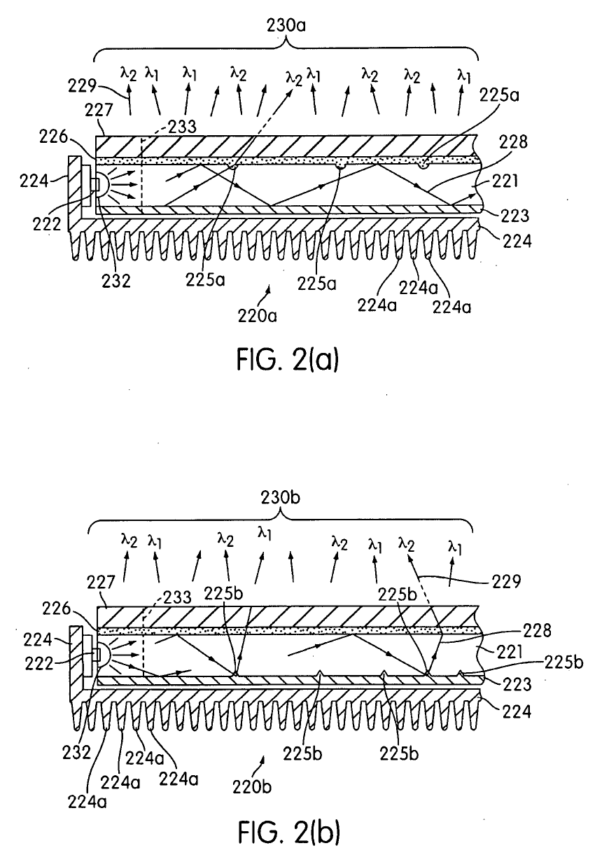

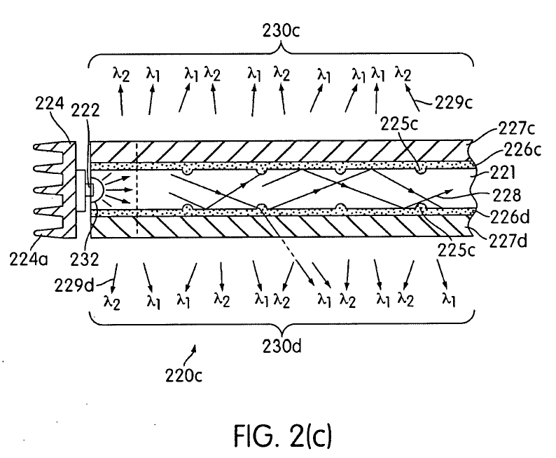

FIG. 2(a) is a cross-sectional schematic of a light emitting panel (lighting panel) 220a in accordance with the invention. The lighting panel 220a is intended for use in a suspended (drop) ceiling of a type commonly used in offices and commercial premises in which a grid of support members (T bars) are suspended from the ceiling by cables and ceiling tiles are supported by the grid of support members. The ceiling tiles are typically square (60 cm×60 cm) or rectangular (120 cm×60 cm) in shape and the lighting panel of the invention is configured to fit within such size openings.

In one embodiment of the invention the lighting panel comprises a square or rectangular sheet of transparent material 221 hereinafter termed a light guide. Blue (400 nm to 480 nm) light emitting LEDs 222 are mounted at each corner of the planar light guide 221. The light guide 221 can be constructed from any material which is transparent to light emitted by the LEDs 222 and typically comprises a sheet plastics material such as a polycarbonate, an acrylic or a glass. The blue LEDs 222, which typically comprise an array of co-packaged InGaN/GaN (indium gallium nitride/gallium nitride) based LED chips, are mounted in thermal communication with a heat sink 224 which can be configured to run along the edges of the light guide. Additionally, as illustrated in FIG. 2(a), the heat sink can extend over the non-light emitting (rear) surface of the panel and preferably includes a plurality of heat radiating fins 224a to aid in dissipation of heat. The light guide 221 is dimensioned such that the overall size of the lighting panel 220, including the heat sink 224 around the peripheral edge, will fit into a tile aperture of a standard suspended ceiling.

On the non-light emitting face (the lower face as illustrated) of the light guide 221, that is the face directed toward the supporting ceiling in operation, a layer of reflective material 223 is provided to prevent the emission of light from the rear of the lighting panel 220a. The reflective material 223 can comprise a metallic coating such as chromium or a glossy white material such as a plastics material or paper. To minimize light being emitted from the edges of the light guide 221, the edges of the light guide preferably include a reflecting surface (not shown in FIG. 2(a)).

The light emitting face of the light guide 221 is patterned with optical features (discontinuities) 225a that ensure preferential light emission at the location of the features. As is further described below, the features 225a are configured in a pattern such as to reduce, preferably minimize, a variation in emitted light intensity over substantially the entire surface of the light emitting face, that is the pattern of features promotes a substantially uniform light emission intensity from the light emitting face of the panel. A phosphor (photo-luminescent) material 226 is provided overlying the entire light emitting face of the light guide and a transparent front protection layer 227 provided over the phosphor to provide environmental protection of the phosphor 226.

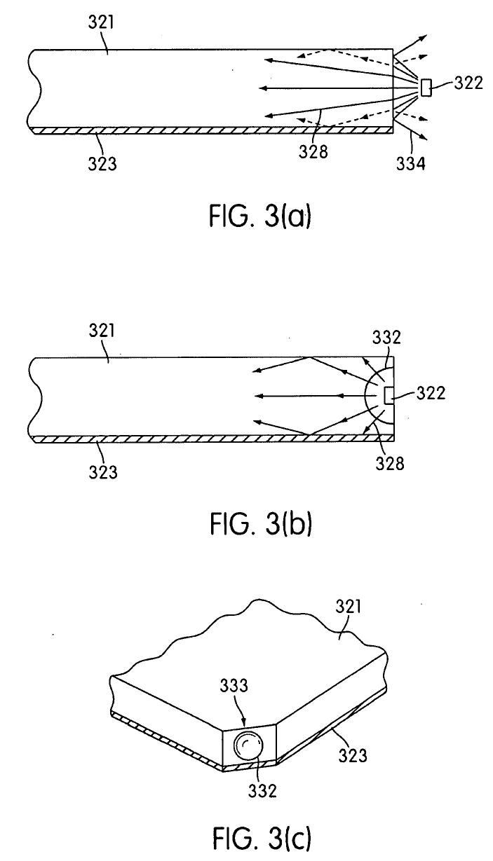

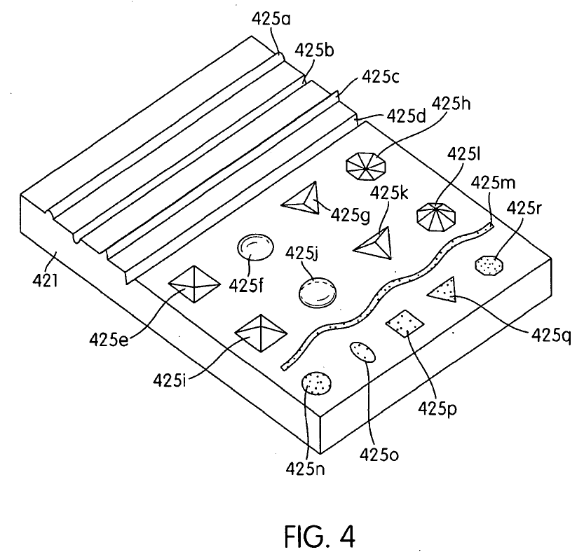

To enable the coupling of light 228 emitted by the LEDs 222 into the light guide 221 each corner of the light guide is truncated 233 and light is coupled into the face of the truncated corner by means of a generally hemispherical (dish-shaped) indentation 232. Throughout this specification like reference numerals preceded by the figure number corresponding to a given embodiment are used to denote like parts. For example the light guide 221 of FIG. 2 is respectively denoted 321, 421, 521, 621, 721, 821, 912, 1021, 1121 in FIGS. 3 to 11 and the features 225 of FIG. 2 are respectively denoted 425, 525, 625, 725, 825, 925, 1025, 1125 in FIGS. 4 to 11.

FIGS. 3(a) and 3(b) illustrate how the hemispherical indentation 332 enhances the coupling of light 328 into the light guide 321. Referring to FIG. 3(a) there is shown a schematic cross-sectional representation of a light guide 321 and coupling of light into a planar edge of the light guide. Light that strikes the edge of the light guide 321 perpendicularly is coupled into the light guide. Since the LED 322 emits light with a radial distribution, light will also strike the edge of the light guide with a range of angles to the normal. For light that strikes the edge at angles equal to or greater than the critical angle this light 334 will be reflected by the edge of the light guide 321 and lost. FIG. 3(b) is a schematic cross-sectional representation of a light guide 321 that includes a hemispherical indentation 332 in the edge of the light guide for maximizing coupling of light into the light guide. In such an arrangement the LED 322 is positioned at the center of the hemispherical indentation such that for all angles of light emission, light will strike the curved surface of the indentation substantially perpendicularly and will be coupled into the light guide. The curvature and size (diameter) of the indentation is selected in dependence on the emission profile of the LED to maximize coupling of light into the light guide. Moreover, it will be appreciated that when using an array of LEDs it is preferred to use a matching array of indentations in which there is an indentation corresponding to each LED of the array. FIG. 3(c) is a schematic perspective representation illustrating the truncated corner 333 and a single hemispherical indentation 332.

Referring back to FIG. 2(a) in operation light (excitation radiation) 228 emitted by the LEDs 222, which is of a first wavelength range λ₁ (blue in this example), is coupled into each truncated corner of the light guide 221 and is guided within the entire volume of the light guide 221 by total internal reflection. Light 228 that strikes one of the optical features 225a will be emitted through the light emitting face of the light guide at the location of the feature and causes excitation of the phosphor material 226 which re-emits light 229 of a second longer wavelength range λ₂. Light 230 output from the light emitting face of the lighting panel which comprises the final illumination product is a combination of the excitation radiation (λ₁) 228 and the light 229 generated by the phosphor (λ₂). In general lighting applications the illumination product will typically be white light and the phosphor 226 can comprise a mixture of green (525 to 535 nm) and orange (590 to 610 nm) emissive phosphors which are excitable by blue light. The correlated color temperature (CCT), measured in degrees Kelvin, of light produced by the panel can be selected by the quantity per unit area (density) or thickness of the phosphor and/or composition of phosphor material(s). In other arrangements the panel can be configured to produce colored light by appropriate selection of the phosphor material, thickness and/or color (wavelength) of the excitation radiation.

An advantage of the light emitting panel of the invention is its compact nature, especially overall thickness of the fixture which can be substantially the same as the thickness of the light guide, typically 10 to 20 mm in thickness. Although the lighting panel is described as being for use in a suspended ceiling it can also be used on a wall, flush with a ceiling, as a part of a floor or any horizontal surface such as a counter top or other surfaces such as stair treads or risers. Moreover, the panel can be used as a part of a structural or decorative component of a building or piece of furniture. In the case of stair treads or risers the light guide is preferably a laminated glass construction with the phosphor being incorporated within one of the intervening laminations.

The light source of the invention is particularly suited for use with inorganic phosphors such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in our co-pending patent applications US2006/0145123, US2006/0261309, US2007/0029526 and patent U.S. Pat. No. 7,311,858 (also assigned to Intematix Corporation) the content of each of which is hereby incorporated by way of reference thereto.

As taught in US2006/0145123, a europium (Eu²⁺) activated silicate-based green phosphor has the general formula (Sr,A₁)ₓ(Si,A₂)(O,A₃)₂₊ₓ:Eu²⁺ in which: A₁ is at least one of a 2⁺ cation, a combination of 1⁺ and 3⁺ cations such as for example Mg, Ca, Ba, zinc (Zn), sodium (Na), lithium (Li), bismuth (Bi), yttrium (Y) or cerium (Ce); A₂ is a 3⁻, 4⁺ or 5⁺ cation such as for example boron (B), aluminum (Al), gallium (Ga), carbon (C), germanium (Ge), N or phosphorus (P); and A₃ is a 1⁻, 2⁻ or 3⁻ anion such as for example F, Cl, bromine (Br), N or S. The formula is written to indicate that the A₁ cation replaces Sr; the A₂ cation replaces Si and the A₃ anion replaces oxygen. The value of x is an integer or non-integer between 1.5 and 2.5.

U.S. Pat. No. 7,311,858 discloses a silicate-based yellow-green phosphor having a formula A₂SiO₄:Eu²⁺D, where A is at least one of a divalent metal comprising Sr, Ca, Ba, Mg, Zn or cadmium (Cd); and D is a dopant comprising F, Cl, Br, iodine (I), P, S and N. The dopant D can be present in the phosphor in an amount ranging from about 0.01 to 20 mole percent and at least some of the dopant substitutes for oxygen anions to become incorporated into the crystal lattice of the phosphor. The phosphor can comprise (Sr_{1-x-y}BaₓM_{y})SiO₄:EU²⁻D in which M comprises Ca, Mg, Zn or Cd and where 0≦x≦1 and 0≦y≦1.

US2006/0261309 teaches a two phase silicate-based phosphor having a first phase with a crystal structure substantially the same as that of (M1)₂SiO₄; and a second phase with a crystal structure substantially the same as that of (M2)₃SiO₅ in which M1 and M2 each comprise Sr, Ba, Mg, Ca or Zn. At least one phase is activated with divalent europium (Eu²⁺) and at least one of the phases contains a dopant D comprising F, Cl, Br, S or N. It is believed that at least some of the dopant atoms are located on oxygen atom lattice sites of the host silicate crystal.

US2007/0029526 discloses a silicate-based orange phosphor having the formula (Sr₁₋ₓMₓ)_{y}Eu_{z}SiO₅ in which M is at least one of a divalent metal comprising Ba, Mg, Ca or Zn; 0<x<0.5; 2.6<y<3.3; and 0.001<z<0.5. The phosphor is configured to emit visible light having a peak emission wavelength greater than about 565 nm.

The phosphor can also comprise an aluminate-based material such as is taught in our co-pending patent application US2006/0158090 and patent U.S. Pat. No. 7,390,437 (also assigned to Intematix Corporation) or an aluminum-silicate phosphor as taught in co-pending application US2008/0111472 the content of each of which is hereby incorporated by way of reference thereto.

US2006/0158090 teaches an aluminate-based green phosphor of formula M₁₋ₓEuₓAl_{y}O_{[1+3y/2]} in which M is at least one of a divalent metal comprising Ba, Sr, Ca, Mg, Mn, Zn, Cu, Cd, Sm or thulium (Tm) and in which 0.1<x<0.9 and 0.5≦y≦12.

U.S. Pat. No. 7,390,437 discloses an aluminate-based blue phosphor having the formula (M₁₋ₓEuₓ)_{2-z}Mg_{z}Al_{y}O_{[2+3y/2]} in which M is at least one of a divalent metal of Ba or Sr. In one composition the phosphor is configured to absorb radiation in a wavelength ranging from about 280 nm to 420 nm, and to emit visible light having a wavelength ranging from about 420 nm to 560 nm and 0.05<x<0.5 or 0.2<x<0.5; 3≦y≦12 and 0.8≦z≦1.2. The phosphor can be further doped with a halogen dopant H such as Cl, Br or I and be of general composition (M₁₋ₓEuₓ)_{2-z}Mg_{z}Al_{y}O_{[2+3y/2]}:H.

US2008/0111472 teaches an aluminum-silicate orange-red phosphor with mixed divalent and trivalent cations of general formula (Sr_{1-x-y}MₓT_{y})₃₋ₘEuₘ(Si_{1-z}Al_{z})O₅ in which M is at least one divalent metal selected from Ba, Mg or Ca in an amount ranging from 0≦x≦0.4; T is a trivalent metal selected from Y, lanthanum (La), Ce, praseodymium (Pr), neodymium (Nd), promethium (Pm), samarium (Sm), gadolinium (Gd), terbium (Tb), dysprosium (Dy), holmium (Ho), Erbium (Er), Tm, ytterbium (Yt), lutetium (Lu), thorium (Th), protactinium (Pa) or uranium (U) in an amount ranging from 0≦y≦0.4 and z and m are in a range 0≦z≦0.2 and 0.001≦m≦0.5. The phosphor is configured such that the halogen resides on oxygen lattice sites within the silicate crystal.

It will be appreciated that the phosphor is not limited to the examples described herein and can comprise any phosphor material including both organic or inorganic phosphors such as for example nitride and/or sulfate phosphor materials, oxy-nitrides and oxy-sulfate phosphors or garnet materials (YAG).

As illustrated in FIG. 2(a), the phosphor material, which is typically in powder form, can be mixed in a pre-selected proportion with a transparent binder material such as a epoxy, silicone or other polymer material and the mixture applied to the face of the front protection layer 227 that faces the light emitting face of the light guide 221. An example of a suitable silicone material is GE's silicone RTV615. The weight loading of phosphor to silicone is typically in a range 35 to 65 parts per 100 with the exact loading depending on the target color or CCT of the illumination product of the lighting panel 220a. In other arrangements, the phosphor material can be deposited directly on to the light emitting face of the light guide 221. The phosphor material(s) can be deposited using any technique such as for example spin coating, tape casting using a doctor blade, ink jet printing, spraying etc. It is also contemplated to deposit the phosphor material as a pattern comprising for example an array of equally spaced non-overlapping areas (dots) of varying size using a halftone system as for example is described in our co-pending patent application US 2007/0240346 the content of which is hereby incorporated by way of reference thereto. When using two different phosphor materials the dots alternate between phosphor materials and the relative size and/or spacing of the dots is used to control the relative quantities of the two phosphors. The pattern of phosphor materials can conveniently be produced by screen printing the phosphor materials.

In a further arrangement the phosphor can be incorporated in a sheet of transparent material, typically a polymer, such as a polycarbonate, silicone or epoxy materials. Such a phosphor sheet is conveniently fabricated by extruding the phosphor/polymer mixture to form a homogeneous phosphor/polymer sheet with a uniform distribution of phosphor throughout its volume. The phosphor sheet can then be positioned overlying the light emitting face of the light guide. In such an arrangement there is no need for a separate front protection layer 227.

In further embodiments of the invention and as is illustrated in FIG. 2(b) the optical features 225b can be provided on the non-light emitting face of the light guide 221. In such an arrangement light that is emitted by the features 225b is reflected by the reflecting layer 223 back through the light guide 221 and is emitted through the light emitting face.

As well as light emitting panels having a single light emitting face it is also contemplated to provide a light emitting panel in which light is emitted from both faces of the light guide as, for example, is illustrated in FIG. 2(c). Such a lighting panel 220c can, for example, be used a dividing partition between cubicles in an office. In such an embodiment a respective pattern of features 225c, 225d is provided on each face of the light guide 221. In applications where it is required that the light emission 230c, 230d from the respective faces is substantially identical the pattern of features 225c, 225d will be substantially identical. Conversely, in applications where it is required to have different light emissions from each face differing patterns of features can be used on each face. To achieve a desired color of emitted light 230c, 230d a respective phosphor material 226c, 226d is provided over each light emitting face of the light guide 221. To provide environmental protection of the phosphor 226c, 226d a transparent front protection layer 227c, 227d is provided over each phosphor. Alternatively, the phosphor material can be incorporate in a transparent material such as a polymer and a sheet of phosphor material fabricated that are then positioned overlying the faces of the light guide. Generally, the phosphor materials 226c, 226d will be the same such that the same color of light is emitted from each face. However, it is also contemplated to use different phosphor material(s) on each face or omit the phosphor on one face such that the panel emits different colors and/or color temperatures of light from each face. Such an arrangement can be used as a suspended lighting panel in which up lighting towards a ceiling is one color and down lighting a different color.

Referring to FIG. 4 there are shown examples of optical features (optical discontinuities) 425a-425o that are used to reduce the variation in emitted light intensity over the entire surface of the light emitting face, that is the pattern of features promotes a more uniform emission of light from the light emitting face of the light guide 421. Typically use of the pattern of features ensures a variation in intensity of about 25% or less to be achieved though in some implementations it is contemplated that by careful optimization a variation of about 10% or less is possible. FIG. 4 shows more detailed depictions of the features 225a, to 225d in FIGS. 2(a) to 2(c). The configuration (layout or pattern) of features necessary to reduce the variation in emitted intensity is described below. The features 425 can broadly be classified into two groups: (i) those that are 3-dimensional in form and project from or extend into a face (light emitting face and/or opposite face) of the light guide and (ii) those that are essentially 2-dimensional in form.

In the case of the first group of features these will in general be made of the same material as that of the light guide 421 and as described they can be provided on the light emitting and/or opposite face of the light guide. As is illustrated in FIG. 4 examples of such features include semicircular ridges 425a, u-shaped grooves 425b, v-shaped ridges 425c, v-shaped grooves 425d, pyramidal indentations 425e, hemispherical or dish shaped indentations 425f, tetrahedral indentations 425g, multi-faceted (trapezohedral) indentations 425h, pyramidal projections 425i, hemispherical projections 425j, tetrahedral projections 425k or multi-faceted (trapezohedral) projections 425l. The ridges and grooves 425a to 425d can comprise essentially straight lines as illustrated or comprise curved lines. Features that project from the light guide, and those comprising indentations with multiple-facets, are most conveniently formed as an integral part of the light guide by for example precision molding of the light guide 421. The features can also be formed by mechanical means such as selectively grinding, milling, drilling, abrading, scribing or by laser ablating the face(s) of the light guide.

In the case of the second group of features, these can comprise applying a different material to the face of the light guide or processing the face of the light guide to define the feature. In the case of the former the material applied to the light guide is preferably transparent or translucent and has an index of refraction that is substantially the same, or similar to, the index of refraction of the light guide to provide index matching and preferential emission of light at the feature. In one embodiment the material comprises an ink and a desired pattern of features can be deposited on the face of the light guide by, for example, screen or ink jet printing. Other deposition techniques will be apparent to those skilled in the art. Alternatively, the features can be defined by processing the face of the light guide by for example by selectively chemically etching the light guide face; selectively mechanically abrading the light guide face using for example grinding, milling, drilling, abrading, blasting with abrasive particles or scribing; or by laser ablation of the light guide face. In FIG. 4 the features illustrated can comprise lines (straight or curved) 425m or be substantially circular 425n, ellipsoidal 425o, square 425p, triangular 425q or hexagonal 425r in shape.

It will be appreciated that the features described are examples only and that the features can be of virtually any form provided that the feature has a form which affects (disrupts or perturbs) the waveguiding properties of the light guide at the location of the feature. Accordingly, other feature forms will be readily apparent to those skilled in the art and can include irregular forms. For ease of fabrication, however, simple geometric shapes such as circles or lines are preferred.

In accordance with the invention the features 425 are configured in a pattern such as to reduce, preferably minimize, the variation in emitted light intensity over substantially the entire surface of the light emitting face. In one arrangement the pattern of features is configured at least in part in dependence on a light intensity distribution within the light guide which can be calculated or derived empirically. The light intensity distribution will depend on the position, number, intensity and emission angle of the light sources. Since the light intensity distribution within the light guide will be non-uniform, the position, spacing, size, shape and/or density of features necessary to achieve a substantially uniform emission intensity of light can vary across the light guide. For example the spacing of features (the closer the spacing of features the more light will be extracted in that area) will depend on distance from each light source (typically corners of the light guide) and will typically reduce as the intensity falls with increasing distance from each light source. Alternatively and/or in addition the size and/or shape of the features can depend upon the distance from each light source. Moreover, the pattern can also be configured such that the number of features per unit area increases in dependence on distance from each light source.

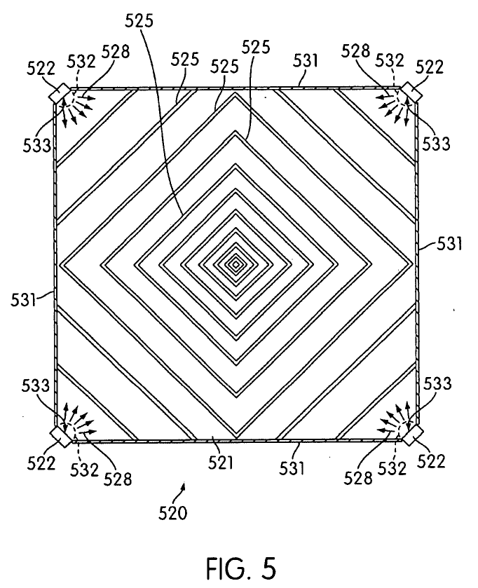

Examples of lighting panels in accordance with the invention will now be described with reference to FIGS. 5 to 11 of the accompanying drawings. For ease of understanding these figures do not show a phosphor layer as this would obscure the pattern of features. FIG. 5 is a schematic representation in plan view of a light emitting panel 520 in which the light guide 521 is square in shape (300 mm by 300 mm) and one or more high power blue emitting LED 522 is provided at each truncated corner 533 of the light guide 521. The LEDs 522 are, in terms of electro-optical properties, preferably substantially identical and each has substantially the same emission intensity and profile (emission angle). In practice each LED 522 comprises an array of co-packaged LED chips to increase the emission intensity of the lighting panel. Each truncated corner 533 of the light guide 521 includes a hemispherical indentation 532 corresponding to each LED to maximize the coupling of light 528 into the light guide from its associated LED. FIG. 5 illustrates a single indentation 532 at each corner though in implementations in which an LED array is used a corresponding array of indentations can be used to optimize coupling of light into the light guide. In the embodiment of FIG. 5 the features 525 comprise a pattern of u- or v-shaped straight line grooves (e.g. 425b, 425d of FIG. 4) or ridges (e.g. 425a, 425c of FIG. 4). Typically, the grooves/ridges are between 0.5 and 1 mm in width and can be formed by precision molding the light guide 521. Alternatively, in the case of grooves these can be defined in one or both faces of the light guide by for example milling or scribing.

The pattern of features 525 are configured to define a series of concentric squares that are centered on the center of the face light guide 521. The series of squares are oriented such that their sides are at an angle of 45° to the edges of the light guide, that is the sides of the squares are orthogonal to the diagonals of the light guide. The spacing between concentric squares can, as shown, decrease towards the center of the light guide 521 resulting in the density of features 525 increasing with increasing distance from each LED 522. In the embodiment illustrated the spacing between features decreases by a fixed distance, for example 0.1 to 10 mm with the density of features being highest at the center of the light guide where the light intensity will be lowest. For a square light guide the furthest point from any one of the LEDs is the center point of the panel which is 212 mm from each corner for a 300 mm square panel and thus the spacing between features reduces by a fixed distance in a range 0.05 to 4.73% of this maximum distance. In a typical implementation it is contemplated that the features will occupy between 10 and 50% of the total area of the face of the light guide. However, for ease of understanding much fewer features are depicted in the FIG. 5. Such a pattern of features 525 is found to reduce the variation in emitted light intensity over the light emitting face of the panel and promote a substantially uniform light emission intensity from the entire surface of the light emitting face. By appropriate selection and configuration of the pattern of features a variation in emitted light intensity of about 25% or less can be achieved and for an optimized pattern a variation of less than 10% is contemplated. In other embodiments the features can be equally spaced and/or the size of the features changed with distance from each LED.

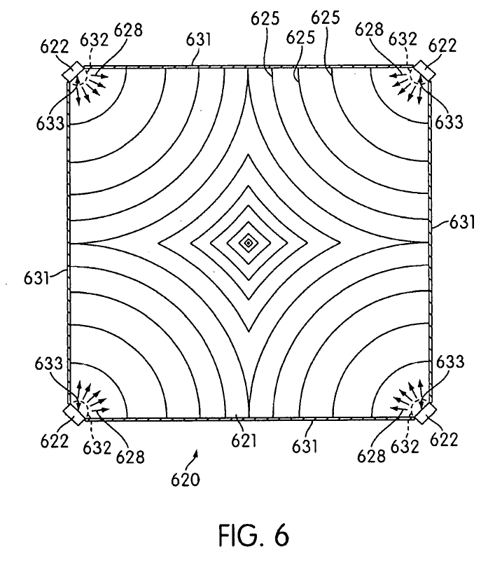

FIG. 6 is a schematic representation in plan view of a light emitting panel according to a further embodiment of the invention. In this embodiment the light guide 621 is again square in shape and the features 625 comprise curved grooves or ridges. The pattern of features comprises four series of concentric circular arcs in which each series has a common center located at the position of its associated LED 622 (that is at a respective corner of the light guide). It is to be noted that distance between circular arcs of each series decreases in a radial direction with increasing distance from the associated LED. As with the embodiment of FIG. 5 the spacing between the features can decrease by a fixed distance resulting in a pattern of features in which the density of features increases symmetrically from each corner towards the center of the face of the light guide. Such a pattern of features 625 is found to reduce the variation in emitted light intensity over the light emitting face of the panel and promote a substantially uniform light emission intensity from the entire surface of the light emitting face.

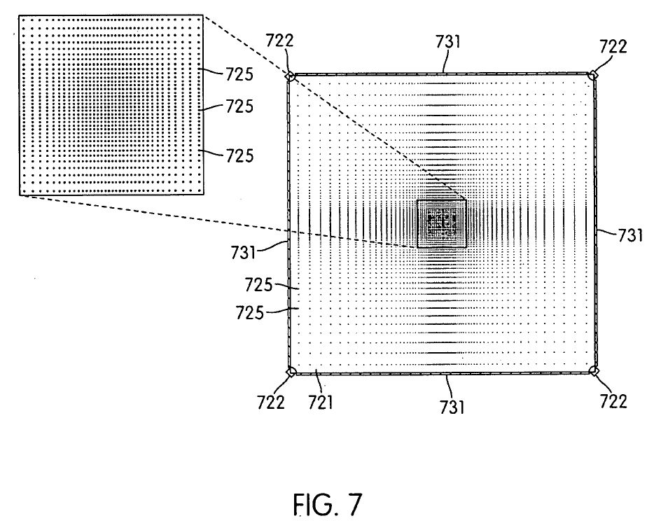

FIG. 7 is a schematic representation in plan view of a light emitting panel 720 according to a further of the embodiment of the invention. In this embodiment the light guide 721 is square in shape (600 mm by 600 mm) and the features 725 comprise substantially hemispherical indents (e.g. 425f of FIG. 4) or hemispherical projections (e.g. 425j of FIG. 4). Typically the hemispherical features are 0.5 to 1 mm in diameter. The features 725 lie on the sides of a series of concentric squares in which the sides of the series of squares are parallel to the edges of the light guide. As can be seen from FIG. 7 the spacing between consecutive squares decreases in a direction towards the center of the light guide face. Furthermore the spacing between features 725 along the sides of the squares also decreases towards the midpoint of each side with the spacing being dependent on a polynomial function. The spacing between features was calculated using a fourth order polynomial of general form:

spacing d=A+Bi+Ci²+Di³+Ei⁴

where i is a radial distance from the center of the face of the light guide and A, B, C, D and E are constants. The values for the constants A, B, C, D and E are preferably optimized with the aid of a ray tracing program, such as “LightTools” by Optical Research Associates based in Pasedena Calif. USA, to simulate the light emission distribution of the light emitting panel for a range of values of the constants and selecting the constants that give the lowest variation in emitted light intensity (that is the most uniform intensity of emitted light). In the embodiment illustrated in FIG. 7 the spacing between the features varies from 23 mm at the edges of the light guide to 1 mm at the center of the light guide which represents a range 0.33 to 7.67% of the maximum distance from each LED. FIG. 7 also shows an enlarged portion of the center region of the pattern of features 725. As can be seen from FIG. 7 the spacing between the features 725 decreases with increasing distance from the LEDs 722 and the pattern at least in part takes account of the light intensity distribution within the light guide. Moreover, it will be appreciated that a higher density per unit area of features should be provided at regions of the light guide where the light intensity is lower and consequently the lowest density of features are those regions closest to the LEDs. It will be apparent to those skilled in the art that the spacing and/or positioning of features can be calculated using other mathematical functions such as lower or higher order polynomials, linear or exponential functions to name but a few.

Moreover, it is to be noted that in determining the configuration of features, account can also be taken that preceding features (i.e. those closer to the light source) will have extracted light from the light guide and have consequently affected the light distribution within the light guide.

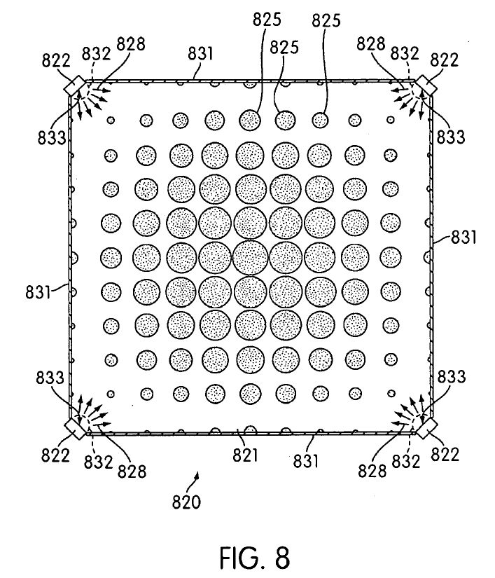

FIG. 8 is a schematic representation in plan view of a light emitting panel 820 according to a yet further embodiment of the invention. In this embodiment the light guide 821 is square in shape (600 mm by 600 mm) and the features 825 comprise substantially circular two-dimensional surface features (e.g. 425n of FIG. 4). As well as the spacing and/or position of features depending at least in part on the intensity distribution within the light guide and varying with distance from the LED light sources, the size of the features 825 can also vary. In FIG. 8 the circular features 825 are located on a regular square array and the radius of the features increases in a direction towards the center of the light guide. Furthermore the radius of the circular features 825 increases in a direction parallel with the edges of the light guide towards the midpoint of each row/column of the array. The radius of the circular features was calculated using a polynomial function of general form:

radius of feature=A−Bx²−Cy²

where x and y are the horizontal and vertical distances from the center of the light guide face and A, B and C are constants. It is contemplated that the density of features per unit area, that is the packing fraction, can range from less than 1% close to the LEDs and about 80% near the center of the panel for a pattern comprising a square array of circular features. For a pattern of circular features in which the features are positioned on a 2-dimensional hexagonal array the packing fraction can vary in a range of 1% to approximately 91%.

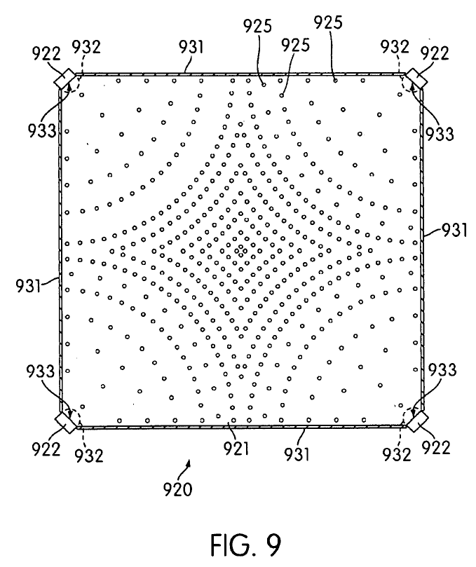

FIG. 9 is a schematic representation in plan view of a light emitting panel 920 according to a yet still further embodiment of the invention. In this embodiment the light guide 921 is square in shape and the features 925 comprise substantially hemispherical indents (e.g. 325f of FIG. 3) or hemispherical projections (e.g. 325j of FIG. 3). Typically the hemispherical features are 0.5 to 1 mm in diameter. The features 925 lie on four series of concentric circular arcs in which each series has its center located at the position of its associated LED 924. It is to be noted that distance between circular arcs of a given series decreases with increasing distance from the associated LED in a radial direction and that the spacing between features in a circumferential direction also decreases with distance from the LED. Such a pattern of features 925 is found to reduce the variation in emitted light intensity over the light emitting face of the panel and promote a generally uniform light emission intensity from the entire surface of the light emitting face. As with other embodiments of the invention by appropriate selection and configuration of the pattern of features a variation in emitted light intensity of about 25% or less can be achieved and for an optimized pattern a variation of about 10% or less is contemplated.

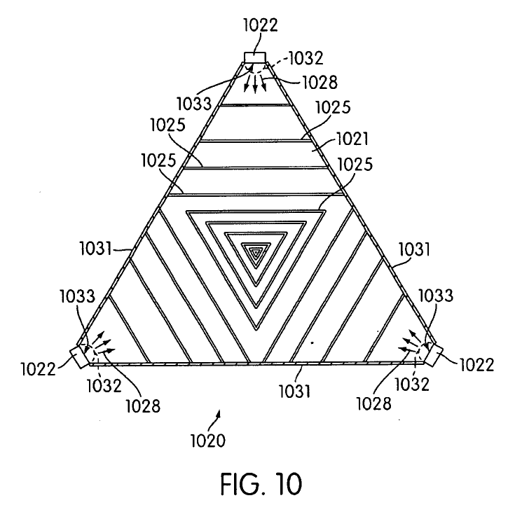

FIG. 10 is a schematic representation in plan view of a light emitting panel 1020 according to a yet further embodiment of the invention. In this embodiment the light guide 1021 is an equilateral triangle in shape and one or more LEDs 1022 are provided at each truncated corner (vertex) 1033. As illustrated the features 1025 comprises straight line grooves/ridges that define a series of concentric equilateral triangles in which the vertices of the triangular features correspond to the midpoint of the edges of the light guide 1021. The distance between consecutive triangles decreases with increasing distance from the associated LED.

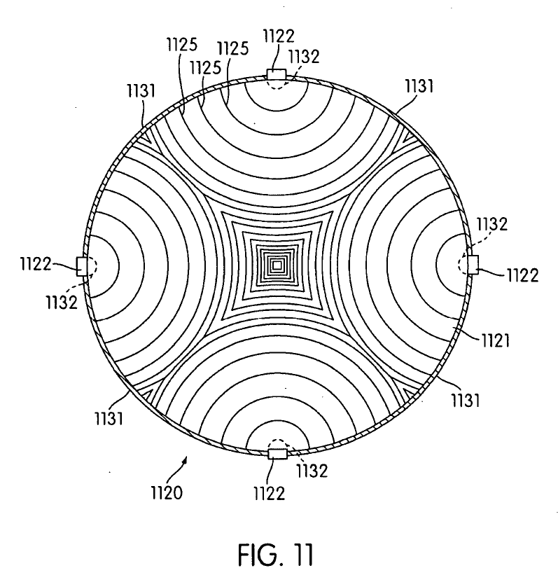

FIG. 11 is a schematic representation in plan view of a light emitting panel 1120 according to a yet further embodiment of the invention. In this embodiment the light guide 1121 is circular in shape (disc shaped) and LEDs 1122 are provided at each of four locations around the circumference of the light guide. As illustrated the LEDs 1122 are preferably positioned at orthogonal locations around the circumferential edge. In this embodiment the pattern of features comprises four series of concentric circular arc ridges/grooves 1125 in which each series has a common center located at the position of its associated LED 1122. The distance between circular arcs of each series decreases in a radial direction with increasing distance from the associated LED. To optimize the coupling of light from the LEDs into the light guide 1121 one or more hemispherical indentations 1132 can be provided in the edge of the light guide and the LEDs positioned at the center of the associated indentation. By limiting the number of locations (positions) at which LEDs are provided can significantly reduce the cost of the panel.

It will be appreciated that the present invention is not restricted to the specific embodiments described and that variations can be made that are within the scope of the invention. For example, the pattern of features can comprise any pattern such as for example helical (spiral) patterns, concentric circles and ellipses to name a few, provided that it reduces the variation in emitted light intensity over the surface of the light emitting face.

The phosphor material can additionally and/or alternatively be provided on the opposite face of the light guide to that of the light emitting face. In such arrangements a reflecting layer should be provided over the surface of the phosphor to reflect phosphor generated light back through the light guide toward and out of the light emitting face.

The features can further comprise a pattern of phosphor material(s) applied to the face of the light guide. For example the pattern of circular features 825 in the light emitting panel 820 of FIG. 8 can comprise a pattern of phosphor material(s). For ease of fabrication the pattern of phosphor material(s) can be screen printed onto the face of the light guide.

It is also contemplated to provide the phosphor material(s) in a pattern corresponding to that of the pattern of features. In one implementation where the features extend into the light emitting face of the light guide the phosphor material(s) is/are accommodated within the recesses defined by the features. An advantage of such an arrangement is that light emission from the light guide occurs at the same location as that of the phosphor material thereby reducing the quantity of phosphor material(s) required. The phosphor material(s) can be applied over the entire surface of the light guide and excess material removed using a blade (squeegee) to leave phosphor within the features.

In other arrangements white light sources (typically white LEDs) can be used in which case there is no need for the phosphor material. In such arrangements an additional light diffusing layer can be beneficial for further reduce any variation in of light emission intensity.

In addition to light emitting panels in which the light guiding medium is substantially planar in form it is contemplated in other embodiments that the light guide be fabricated into curved surfaces.

What is claimed is:

1. A light emitting panel comprising:
a polygonal-shaped light guiding medium having a light emitting face, an opposite face and truncated corners,
at least one light source associated with each truncated corner of the light guiding medium and configured to couple light into the associated truncated corner and
a pattern of features on at least one face of the light guiding medium for promoting emission of light from the light emitting face, said pattern of features being configured such that a variation in emitted light intensity over substantially the entire surface of the light emitting face is less than or equal to about 25%.

2. The panel according to claim 1, wherein the pattern of features is selected from the group consisting of: being configured at least in part in dependence on a light intensity distribution within the light guiding medium; a spacing of features reducing in dependence on distance from each light source; a size of features depending at least in part on distance from each light source; a shape of features depending at least in part on distance from each light source; and a number of features per unit area increasing in dependence on distance from each light source.

3. The panel according to claim 1, wherein the features are selected from the group consisting of: ridges; u-shaped ridges; v-shaped ridges; grooves; u-shaped grooves; v-shaped grooves; substantially hemispherical features; substantially pyramidal features; substantially tetrahedral features; substantially trapezohedral features; lines; substantially circular features; substantially elliptical features; substantially square features; substantially rectangular features; substantially triangular features; substantially hexagonal features and substantially polygonal shaped features.

4. The panel according to claim 1, and further comprising at least one substantially hemispherical indentation associated with each light source, said indentations being provided in the truncated corners of the light guiding medium and wherein the associated light source positioned at substantially the center of the indentation.

5. The panel according to claim 4, wherein the features are formed by a method selected from the group consisting of: forming them as an integral part of the light guiding medium; processing a face of the light guiding medium; and applying the features to the face of the light guiding medium.

6. The panel according to claim 5, wherein the method is selected from the group consisting of: precision molding the light guiding medium to define pattern of features, selectively mechanically abrading the face to define the features; selectively grinding the face to define the features; selectively scribing the face to define the features; selectively etching the face to define the features; selectively blasting the face with a abrasive particles and selectively laser ablating the face to define the features.

7. The panel according to claim 1, and further comprising providing a phosphor material over substantially the entire light emitting face of the light guiding medium, wherein the phosphor material is operable to absorb at least a part of the light emitted from the light emitting face and in response emit light of a different wavelength and wherein the light emission product of the panel comprises light generated by the at least one source and the phosphor generated light.

8. The panel according to claim 7, wherein the phosphor material selected from the group consisting of: being provided as at least one layer on the light emitting face of the light guiding medium; being provided as at least one layer on a face of a substantially transparent substrate, wherein the substrate is positioned over the light guiding medium with the layer of phosphor facing the light emitting face of the light guiding medium; and being is incorporated in a sheet of transparent material with a substantially uniform distribution of phosphor throughout its volume, wherein the phosphor sheet is positioned over the light emitting face of the light guiding medium.

9. The panel according to claim 1, wherein the light guiding medium is selected from the group consisting of being: substantially square, substantially rectangular, substantially triangular, and substantially hexagonal in shape.

10. The panel according to claim 1, wherein the light guiding medium is selected from the group consisting of: a polymer, a polycarbonate, an acrylic and a glass.

11. The panel according to claim 1, and further comprising a reflective surface over substantially the entire opposite face of the light guiding medium.

12. The panel according to claim 1, and further comprising at least one light source which is configured to couple light into an edge of the light guiding medium between the truncated corners of the light guiding medium.

13. The panel according to claim 1, and comprising a respective pattern of features on each face of the light guiding medium and wherein in operation light is emitted from both faces of the light guiding medium.

14. A light emitting panel comprising:
a light guiding medium having a light emitting face and an opposite face,
a plurality of light sources configured to couple light into an edge of the light guiding medium at four or fewer locations around the edge and
a pattern of features on at least one face of the light guiding medium for promoting emission of light from the light emitting face, said pattern of features being configured such that a variation in emitted light intensity over substantially the entire surface of the light emitting face is less than or equal to about 25%.

15. The panel according to claim 14, wherein the pattern of features is selected from the group consisting of: being configured at least in part in dependence on a light intensity distribution within the light guiding medium; a spacing of features reducing in dependence on distance from each light source; a size of features depending at least in part on distance from each light source; a shape of features depending at least in part on distance from each light source; and a number of features per unit area increasing in dependence on distance from each light source.

16. The panel according to claim 14, wherein the features are selected from the group consisting of: ridges; u-shaped ridges; v-shaped ridges; grooves; u-shaped grooves; v-shaped grooves; substantially hemispherical features; substantially pyramidal features; substantially tetrahedral features; substantially trapezohedral features; lines; substantially circular features; substantially elliptical features; substantially square features; substantially rectangular features; substantially triangular features; substantially hexagonal features and substantially polygonal shaped features.

17. The panel according to claim 14, and further comprising at least one substantially hemispherical indentation associated with each light source, said indentations being provided in the edge of the light guiding medium and wherein the associated light source is positioned at substantially the center of the indentation.

18. The panel according to claim 14, and further comprising providing a phosphor material over substantially the entire light emitting face of the light guiding medium, wherein the phosphor material is operable to absorb at least a part of the light emitted from the light emitting face and in response emit light of a different wavelength and wherein the light emission product of the panel comprises light generated by the at least one source and the phosphor generated light.

19. The panel according to claim 18, wherein the phosphor material selected from the group consisting of: being provided as at least one layer on the light emitting face of the light guiding medium; being provided as at least one layer on a face of a substantially transparent substrate, wherein the substrate is positioned over the light guiding medium with the layer of phosphor facing the light emitting face of the light guiding medium; and being is incorporated in a sheet of transparent polymer material with a substantially uniform distribution of phosphor throughout its volume, wherein the phosphor sheet is positioned over the light emitting face of the light guiding medium.

20. The panel according to claim 14, wherein the light guiding medium is selected from the group consisting of: being substantially circular; substantially square; substantially rectangular; and substantially triangular in shape.

21. The panel according to claim 14, wherein the light guiding medium is selected from the group consisting of: a polymer; a polycarbonate; an acrylic and a glass.

22. The panel according to claim 14, and further comprising a reflective surface over substantially the entire opposite face of the light guiding medium.

23. The panel according to claim 14, and comprising a respective pattern of features on each face of the light guiding medium and wherein in operation light is emitted from both faces of the light guiding medium.
